(19) United States
(12) Patent Application Publication
(10) Pub. No.: US 2012/0151953 A1
(43) Pub. Date: Jun. 21, 2012

(54) DRAIN PAN RAIL FOR USE IN A HEATING VENTILATION AIR CONDITIONING SYSTEM

(75) Inventors: James Timbs, Winona, MS (US); James Carpenter, Grenada, MS (US)

(73) Assignee: Advanced Distributor Products LLC, Grenada, MS (US)

(21) Appl. No.: 12/971,592

(22) Filed: Dec. 17, 2010

(51) Int. Cl. F25D 21/14; B23P 19/04

(52) U.S. Cl. 62/291; 29/428

(57) ABSTRACT

The present disclosure is directed to an elongated body member configured to be inserted into a heat ventilation air conditioning (HVAC) plenum, said elongated body member having a middle portion, an upper supporting ledge, and a stop tab integrally formed therewith, and wherein said elongated body member is a unitary piece of bent sheet metal. The present disclosure is also directed to employing the drain rail and drain pan within a plenum housing. A method of fabricating a plenum housing the drain rails is also provided.

### TECHNICAL FIELD

This application is directed, in general, to a drain pan rail for use in a heating ventilation and air conditioning (HVAC) system.

### BACKGROUND

HVAC plenums are well known and have been used for decades in the HVAC industry. Typically, the plenums are constructed in a piece meal fashion that requires multiple structural components and fasteners, all of which add material costs and manufacturing time in constructing these units.

### SUMMARY

One aspect provides a drain pan rail, comprising an elongated body member configured to be inserted into a heat ventilation air conditioning (HVAC) plenum. The elongated body member has a middle portion, a lower foot supporting member, and a stop tab attached thereto.

In another embodiment, a heating ventilation air conditioning (HVAC) plenum is disclosed. This particular embodiment comprises a plenum housing frame having a bottom panel and opposing first and second side frame members, a first wall panel located on an end of the plenum housing frame and second and third wall panels located on each of said opposing side frame members. This embodiment further includes at least one drain pan rail located along a length of the first side frame member and within the plenum housing frame, wherein the drain pan rail is a unitary piece of bent sheet metal that comprises an elongated body member configured to be inserted into the plenum housing. The elongated body member has a middle portion, an upper supporting ledge that supports the second wall panel, and a stop tab attached thereto and extending outwardly from the elongated body member and into an interior of the plenum housing. A drain pan is located within the plenum housing frame and abuts the bent tabs of the first and second drain pan rails, and a portion of the at least one drain rail extends along the drain pan.

In another embodiment, a method of manufacturing a heating ventilation air conditioning (HVAC) plenum is disclosed. This method embodiment includes the steps of providing a plenum housing frame having a bottom panel and opposing first and second side frame members. A first wall panel is secured on ends of the first and second side frame members. Second and third wall panels and placed under an upper flange of the first and second side frame members, respectively. First and second drain pan rails are placed along each of the first and second side frame members, wherein the first and second drain pan rails each comprise an elongated body member configured to be inserted into said plenum housing frame. The elongated body member has a middle portion, a foot supporting member that supports the drain pan rail on the bottom panel, and an upper support ledge. The elongated body member also has a stop tab attached thereto and that extends outwardly from the elongated body member. A drain pan is placed between the first and second drain pan rails such that and end of the drain pan abuts the stop tab of each of the first and second drain rails. The second wall panel is supported on the upper support ledge of the first drain pan rail and the third wall panel is supported on the upper support ledge of the second drain pan rail. The second and third wall panels are secured to the first and second drain pan rails and to the plenum housing frame members.

### BRIEF DESCRIPTION

Reference is now made to the following descriptions taken in conjunction with the accompanying drawings, in which:

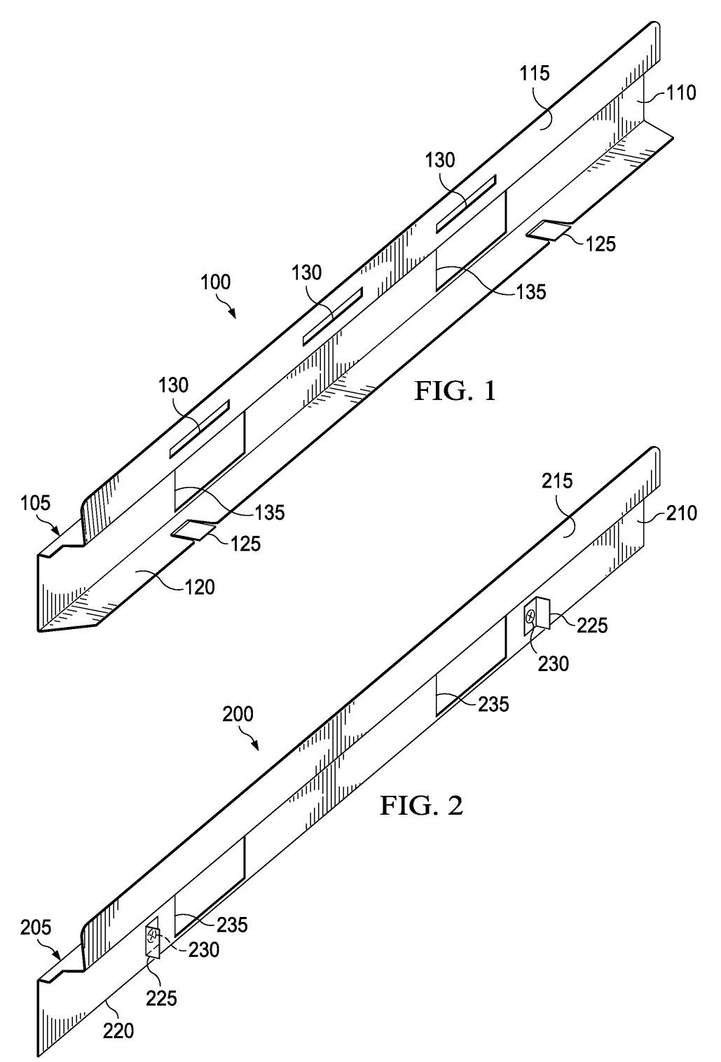

FIG. 1 illustrates one embodiment of a drain pan rail as described herein;

FIG. 2 illustrates another embodiment of a drain pan rail as described herein;

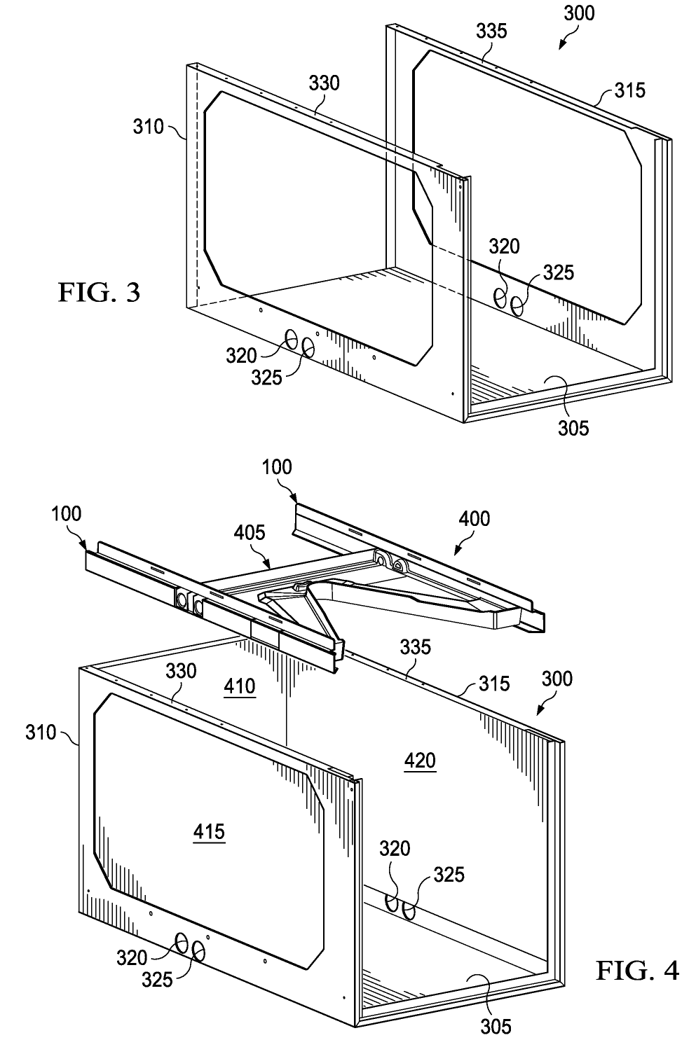

FIG. 3 illustrates a plenum housing frame;

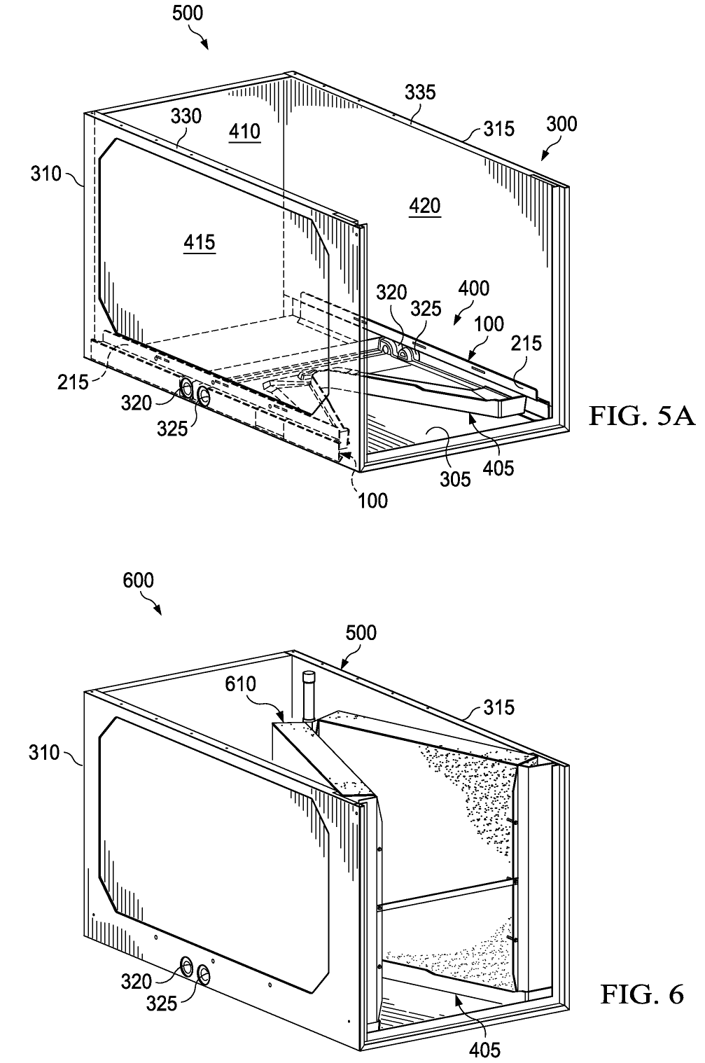

FIG. 4 illustrates an exploded view of the drain pan rails of FIG. 1, a drain pan, and a plenum housing frame;

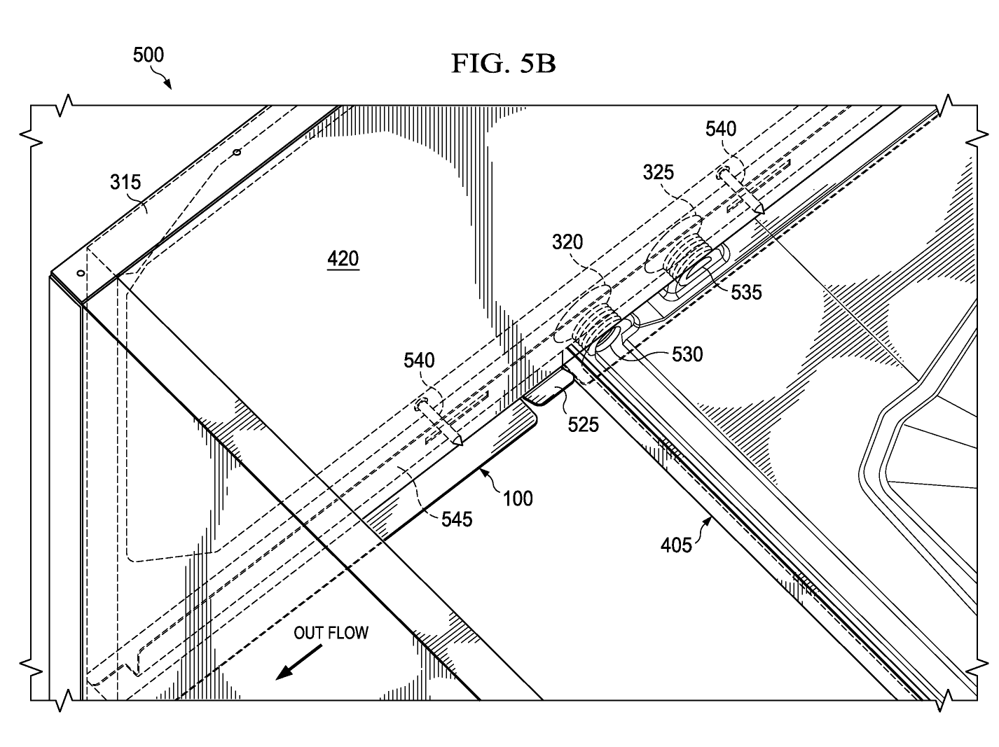

FIG. 5A-5B illustrate the drain pan rails and the drain pan positioned within the plenum housing frame and where the drain pan rails and a wall panel of the plenum housing is secured together with a fastener;

FIG. 6 illustrates the plenum housing having a refrigeration coil positioned therein; and

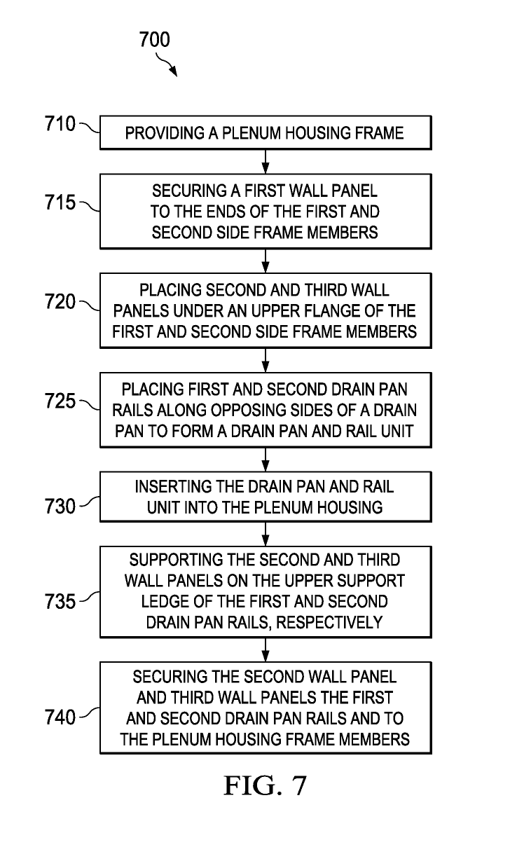

FIG. 7 illustrates a flow diagram of one method embodiment that might be used to fabricate the plenum housing.

### DETAILED DESCRIPTION

FIG. 1 illustrates one embodiment of a drain pan rail 100. In this particular embodiment, the drain pan rail 100 comprises an elongated body member 105 that is configured to be inserted into a heat ventilation air conditioning (HVAC) plenum (not shown) and is formed from a unitary or single piece of sheet metal. The elongated body member 105, as presented in the embodiment of FIG. 1, has a middle portion 110 and an upper supporting ledge 115. In another aspect of this embodiment, the elongated body member 105 may further include an optional foot supporting member 120. The elongated body member 105 further has one or more stop tabs 125 attached thereto.

In this particular embodiment, which includes two stop tabs, the stop tabs 125 are integrally formed with the elongated body member 105; that is, they are formed of the same unitary piece of metal as the elongated body member 105. However, as seen below, in other embodiments, the stop tabs 105 may be separate pieces of metal that are individually attached to the elongated body member 105. In the embodiment illustrated in FIG. 1, the stop tabs 125 may be formed by stamp or die cutting the sides and leaving a hinge portion attached to the main piece of metal from which the elongated body member 105 is formed. This allows the stop tabs 125 to be selectively bent up so that it can act as an alignment stop tab for a drain pan. The stop tabs 125 may be located on the middle portion 110, or alternatively, the stop tabs may be located on the foot supporting member 120. In certain embodiments, the upper supporting ledge 16 may include one or more optional openings 130 through which fasteners may be inserted. The drain pan rail 100 may further include one or more drain openings 135 that are formed in the middle portion 110.

The embodiment shown in FIG. 1 is symmetrical about a centered axis that is perpendicular to its longitudinal axis, which is the axis that extends along the drain pan rail's 100 longest length. This particular embodiment allows the drain pan rail 100 to be rotated such that it can be used on either side of a plenum without the need to alter its configuration, thereby saving additional manufacturing time and costs.

The drain pan rail 100 provides significant improvements over conventional processes that typically involve connecting multiple individual pieces of metal together with a substantial number of fasteners. In contrast, the drain pan rail 100, in various embodiments, provides a unitary piece of shaped or bent metal that replaces the multiple piece collage that typifies conventional plenum designs. As such, manufacturing time and installation costs are significantly reduced.

FIG. 2 illustrates another embodiment of a drain pan rail 200. It should be noted that one or more of the features illustrated in FIG. 2 may optionally appear in combination with the features shown in FIG. 1. In this particular embodiment, the drain pan rail 200 is constructed from a unitary piece of shaped or bent metal that comprises an elongated body 205 and which has a middle portion 210 and an upper support ledge 215. As seen in this figure, the optional foot supporting member 120 of FIG. 1 is not present, thereby leaving the middle portion being located between a bottom edge 220 of the elongated body 205 and the upper support ledge 215. In addition, the optional openings 130 of FIG. 1 are not present. In such instances, the drain pan rail 200 may be secured to a plenum housing with sheet metal screws. One or more stop tabs 225 are also included in this embodiment. However, FIG. 2 illustrates a different embodiment of the stop tabs 225 wherein, the stop tabs 225 are not integrally formed with the elongated body 205, but are instead, individual pieces of shaped metal that are separately attached to the elongated body 205, for example by sheet screws 230. As with the previously described embodiment of FIG. 1, the drain pan rail of FIG. 2 also includes one or more drain openings 235. Similar to the embodiment of FIG. 1, the drain pan rail 200 also has the same type of symmetry about its longitudinal axis that allows it to be used on either side of a plenum housing without the need for structural modifications, and also provides the similar advantages over conventional configurations as the embodiment of FIG. 1.

FIG. 3 illustrates an embodiment of a plenum housing frame 300 in which the drain rails 100 and 200 may be used. The housing frame 300 includes a bottom panel 305 and side frame members 310, 315. The side frame members 310, 315, also includes drain openings 320, 325, one of which is a primary drain opening with the other being a secondary drain opening that allows condensate to drain in the even that the primary drain opening becomes spotted-up. Though the drain openings 320, 325 appear on each side of the plenum housing frame 300, it should be understood that they may be located only on one side. However, when they are on both sides of the plenum housing frame 300, the installer has the option of using either side as may be required in certain installation processes. Additionally, each side frame member 310, 315 includes an upper flange 330, 335, respectively, that can be used to help hold a side wall board in position. In an advantageous embodiment, the housing frame 300 is die stamped or cut from a unitary piece of sheet metal and bent to the configuration shown in FIG. 3. This provides a unitary or one piece housing that does not require assembling multiple sheet metal pieces together with fasteners, which is contrast to conventional processes that, in some instances may use as many as 15 to 25 pieces of sheet metal. As such, the disclosed construction significantly reduces manufacturing time and costs. In another aspect, the drain openings 320, 325 are located in the bottom portions of each of the side frame members 310, 315 and are positioned such that drain ports of a drain pan align with the drain openings 320, 325 when it is inserted into the plenum housing 300.

FIG. 4 illustrates the plenum housing frame 300 of FIG. 3 and a drain pan rail and drain pan assembly 400 prior to its placement within the plenum housing frame 300. At this stage of fabrication, the plenum housing frame 300 further includes a first wall panel 410 located on an out flow end of the plenum housing frame 400 and second and third wall panels 415, 420 located on each of the opposing side frame members 310, 315, respectively. The first wall panel 410 may be attached to the end for the frame members 310, 315 by conventional means. However, at this stage of manufacture, the second and third wall are panels 415, 420 are temporarily held in position within each of the side frame members 310, 315 by the upper flanges 330 and 335. Also, the height of each of the panels 415, 420, is such that it leaves the drain openings 320, 325 unblocked.

In this embodiment, the drain pan rail and drain pan assembly 400 includes two of the drain pan rails 100 as shown in FIG. 1 and described above and a drain pan 405, which may be of conventional design, such as a “V” shaped drain pain. However, the assembly 400 may employ any of the other embodiments of the drain rails as described above. As seen in FIG. 4, a drain rail 100 is located along each side of the drain pan 405, and each has a length that is longer than the length of the drain pan 405 and is substantially the length of the interior of the plenum housing frame 300.

FIG. 5A illustrates a plenum housing 500 with the drain pan rail and drain pan assembly 400 of FIG. 4. positioned therein and the side wall panels 415, 420 supported on the upper support ledge 215 of the drain pan rails 100. FIG. 5B illustrates a close up view of one side of the plenum housing 500 and drain pan rail and drain pan assembly 400 and how end of the drain pan 405 abuts the stop tab 525 as described above regarding FIG. 1. The only stop tab that is turned up is the one toward the front side (out flow side of the plenum housing 500. Though the stop tab of FIG. 1 is shown in this embodiment, it should be understood that the stop tab 525 as well as the drain pan rail 100 could also have the configuration as shown and discussed about regarding alternative embodiments. The stop tab 525 of the drain pan rails 100 centers or self-aligns the location of drain openings 530, 535 of the drain pan 405 with the drain openings 320, 325 of the plenum housing 500; that is when the end of the drain pan 405 abuts the stop tap 525, the drain openings of the drain pan and the plenum housing are aligned and no further adjustments need be made. This feature provides the advantage of saving manufacturing or assembly time.

FIG. 5B also illustrates one embodiment of how the side wall panel 420 can be secured to the side frame member 315 and the drain pan rail 100. In this figure, the side wall panel 420 is secured with fasteners 540, such as screws, bolts or brads, that extend through the upper support ledge 545, which corresponds to designated feature 130 in FIG. 1. The fasteners 540 pulls and secures the side wall panel 420 against the drain pan rail 100 and the plenum housing side frame member 315.

FIG. 6 illustrates a partially completed coil unit 600 that includes the plenum housing 500 and a conventional coil unit 610 located therein. The weight of the coil unit 600 pushes against the drain pan rails, which in turn, pushes against the side frame members 310, 315, while the fasteners 540 (See FIG. 5B) exert a pulling force in the opposite direction, thereby creating a frictional force helps to hold the drain pan 405, and thus the coil unit 601, in the plenum housing 500.

FIG. 7 illustrates a flow chart of one embodiment of a method 700 of manufacturing a HVAC plenum utilizing embodiments of the drain pan rail as provided herein. In step 710 a plenum housing frame, such as the embodiments discussed above, having a bottom panel and opposing first and second side frame members is provided. The plenum housing may be provided by obtaining the plenum housing from another source or by fabricating using, for example, conventional processes. As discussed above, the plenum housing may be formed from a unitary piece of sheet metal and cut and bent to form a unitary frame having comprising the bottom panel and opposing first and second side frame members.

In step 715, a first wall panel is secured to the ends of the first and second side frame members. The wall panel is preferably attached to the out-flow end (i.e., the end through which conditioned air exits the plenum) of the plenum housing. The first wall panel may be of conventional materials, such as insulation duct board material often used in the fabrication of HVAC plenums. Additionally, the first wall panel may be attached using conventional processes, such as metal sheet screws.

In step 720, second and third wall panels are placed under an upper flange of the first and second side frame members, respectively. The flange, which may have a “U” shaped configuration as a width that is slightly smaller than the thickness of the second and third wall panels, which allows the panels to be frictionally held in placed until they are secured to the side frame members and the drain pan rail.

In step 725, first and second drain pan rails are placed along opposing sides of a drain pan to form a drain pan and rail unit, as described above, wherein the first and second drain pan rails each comprise an elongated body member configured to be inserted into the plenum housing frame. The elongated body member has a middle portion, a foot supporting member that supports the drain pan rail on the bottom panel, and an upper support ledge. The elongated body member has a stop tab attached thereto and extends outwardly from the elongated body member and abuts an end of the drain pan.

In step 730, the drain pan and rail unit are inserted into the plenum housing, and in step 735 the second wall panel is supported on the upper support ledge of the first drain pan rail and the wall panel is supported on the upper support ledge of second drain pan rail.

In step 740, the second wall panel and third wall panels are secured to the first and second drain pan rails and to the plenum housing frame members. As discussed above, fasteners, such as screws, bolts or brads or even adhesives may be used to secured the panels. In certain embodiments, the upper support ledges of the drain pan rails may includes optional openings through which screws, bolts or brads may be inserted. Alternatively, however, sheet metal screws may be used to simply drill through the materials to secured the panels in place.

Subsequent to step 740, a conventional refrigeration coil, such as a “V” shaped coil may be positioned within the drain pan, after which conventional processes may be conducted to complete the construction of the HVAC plenum, such as connecting the “V” shaped coils together using a header assembly and adding access and pipe and valve panels.

Those skilled in the art to which this application relates will appreciate that other and further additions, deletions, substitutions and modifications may be made to the described embodiments.

What is claimed is:

1. A drain pan rail, comprising:
an elongated body member configured to be inserted into a heat ventilation air conditioning (HVAC) plenum, said elongated body member having a middle portion, an upper supporting ledge, and a stop tab integrally formed therewith, and wherein said elongated body member is a unitary piece of bent sheet metal.

2. The drain pan rail recited in claim 1, wherein said elongated body member further includes a foot supporting member and said stop tab integrally formed with said foot supporting member.

3. The drain pan rail recited in claim 1, wherein said elongated body member is symmetrical about an axis perpendicular to a longitudinal axis of the elongated body member.

4. The drain pan rail recited in claim 3 wherein said upper supporting ledge has one or more openings formed therethrough.

5. The drain pan rail recited in claim 1, wherein said middle portion includes one or more drain openings formed therethrough.

6. The drain pan rail recited in claim 1, wherein said stop tab is a first bendable tab integrally formed with said elongated body and said elongated body member includes a second bendable tab integrally formed therewith.

7. A heating ventilation air conditioning (HVAC) plenum, comprising;
a plenum housing frame having a bottom panel and opposing first and second side frame members;
a first wall panel located on an end of said plenum housing frame and second and third wall panels located on each of said side frame members;
at least one drain pan rail located along a length of said first side frame member and within said plenum housing frame, wherein said drain pan rail is a unitary piece of bent sheet metal that comprises an elongated body member configured to be inserted into said plenum housing, said elongated body member having a middle portion, an upper supporting ledge that supports said second wall panel, and a stop tab attached thereto and extending outwardly from said elongated body member and into an interior of said plenum housing; and
a drain pan located within said plenum housing frame and abutting said stop tab, a portion of said at least one drain pan rail extending along a side of said drain pan.

8. The HVAC plenum recited in claim 7, wherein said stop tab is integrally formed with said elongated body.

9. The HVAC plenum recited in claim 7, wherein said at least one drain pan rail is a first drain pan rail and said second wall panel is secured to said first drain pan rail and said first side frame member, and said HVAC plenum further including a second drain pan rail located within said plenum housing frame and extending along said second side frame member and along another side of said drain pan, and wherein said third wall panel is secured to said second drain pan rail and said second side frame member.

10. The HVAC plenum recited in claim 9, wherein said upper supporting ledges of each of said first and second drain pan rails include openings formed therethrough and fasteners are located through said second and third wall panels and through said openings of said first and second drain pan rails and through said first and second side frame members.

11. The HVAC plenum recited in claim 7, wherein said elongated body member includes a foot supporting member and said stop tab is located on said foot supporting member of said drain pan rail.

12. The HVAC plenum recited in claim 7, wherein said middle portion includes a drain opening formed therein that is aligned with a drain opening of said drain pan when said drain pan abuts said stop tab.

13. The HVAC plenum recited in claim 7, wherein said stop tab is a first bent tab integrally formed with said elongated body and said elongated body member further includes a second bent tab integrally formed therewith.

14. The HVAC plenum recited in claim 7, wherein said bottom and said first and second side frame members of said plenum housing are comprised of a unitary piece of bent sheet metal.

15. The HVAC plenum recited in claim 7, wherein said stop tabs are located along a length of said elongated body member such that said drain openings of said drain pan are aligned with drain opening of said plenum housing when said drain pan abuts said stop tab.

16. A method of manufacturing a heating ventilation air conditioning (HVAC) plenum, comprising:
providing a plenum housing frame having a bottom panel and opposing first and second side frame members;
securing a first wall panel on ends of said first and second side frame members;
placing second and third wall panels under an upper flange of said first and second side frame members, respectively;
placing first and second drain pan rails along each of said first and second side frame members, wherein said first and second drain pan rails each comprise an elongated body member configured to be inserted into said plenum housing frame, said elongated body member having a middle portion, a foot supporting member that supports said drain pan rail on said bottom panel, and an upper support ledge, said elongated body member having a stop tab attached thereto and extending outwardly from said elongated body member;
placing a drain pan between said first and second drain pan rail an abutting an end of said drain pan against said stop tab of each of said first and second drain pan rails;
supporting said second wall panel on said upper support ledge of said first drain pan rail and supporting said third wall panel on said upper support ledge of said second drain pan rail; and
securing said second wall panel and third wall panels to said first and second drain pan rails and to said plenum housing frame members.

17. The method recited in claim 16, wherein said upper supporting ledges of each of said first and second drain pan rails include openings formed therein and said securing includes placing fasteners through said second and third wall panels and through said openings of said first and second drain pan rails and through said first and second side frame members.

18. The method recited in claim 16, wherein said middle portion of each of said first and second drain pan rails includes a drain opening formed therein that aligns with a drain opening of said drain pan and drain openings of said first and second side frame members when said drain pan abuts said stop tabs within said plenum housing.

19. The method recited in claim 16, wherein said first and second drain pan rails are placed along opposing side of said drain pan to form a drain rail and drain pan unit and placing said first and second drain pan rails and said drain pan in said plenum housing includes placing said drain rail and drain pan unit in said plenum housing.

20. The method recited in claim 16, wherein said drain pan is frictionally secured within said plenum housing frame by said first and second drain pan rails and said first and second side frame members and by securing said second wall panel and third wall panels to said first and second drain pan rails and to said plenum housing frame members.
